(19) United States
(12) Patent Application Publication
(10) Pub. No.: US 2008/0266456 A1
(43) Pub. Date: Oct. 30, 2008

(54) BROADCASTING RECEPTION DEVICE AND SIGNAL PROCESSING METHOD FOR BROADCASTING RECEPTION DEVICE

(75) Inventor: Kohei Miyoshi, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/047,192

(22) Filed: Mar. 12, 2008

(30) Foreign Application Priority Data
Apr. 27, 2007 (JP) 2007-119475

(51) Int. Cl. H04N 5/14; H04N 5/455

(52) U.S. Cl. 348/571; 348/726; 348/E05.113; 348/E05.062

(57) ABSTRACT

According to one embodiment, a broadcasting reception device includes a tuner section which selects and outputs a television broadcasting signal, a demodulating section which demodulates the broadcasting signal from the tuner section so as to output a video signal, a display section which displays a video according to the video signal from the demodulating section on a screen, and a signal processing section which, when a determination is made that a predetermined condition is satisfied, processes the video signal and supplies it to the display section so that the video signal is displayed on the display section by dot-by-dot.

### CROSS-REFERENCE TO RELATED APPLICATIONS

This application is based upon and claims the benefit of priority from Japanese Patent Application No. 2007-119475, filed Apr. 27, 2007, the entire contents of which are incorporated herein by reference.

### BACKGROUND

1. Field

One embodiment of the present invention relates to a broadcasting reception device which clearly displays a PC video as a still image on a display section of the reception broadcasting device, and a signal processing method for the device.

2. Description of the Related Art

Recently, digital devices have been very widely used, and thus one user often owns a lot of digital devices. For example, it is demanded that video signals from a PC are displayed by television receivers. In order to meet the demand, a lot of techniques for displaying PC videos on screens of television receivers are known.

Patent Document 1 (Jpn. Pat, Appln. KOKAI Publication No. 11-298808) discloses that a determination is made whether an input PC video signal is a still image or a moving image, and a display video image is switched according to the determined result.

Patent Document 2 (Jpn. Pat. Appln. KOKAI Publication No. 2004-048224) discloses a video signal converting device using HDMI which receives EDID as information for setting resolution of HDMI and automatically outputs a signal according to EDID so as to display a clear PC video on a screen of a television receiver.

However, the conventional technique in Patent Document 1 causes a defect in which ruled lines of a spreadsheet application are doubled so as to be displayed unclearly by a scaling process on a video signal.

In the case where an aspect ratio for general AV devices is recommended for EDID supplied from a television device to a source device, the conventional technique in Patent Document 2 causes a defect in which the technique cannot cope with this aspect ratio and an unclear image is displayed on a screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of a broadcasting reception device according to one embodiment of the present invention;

FIG. 2 is a flow chart illustrating one example of an aspect ratio changing process in the broadcasting reception device according to one embodiment of the present invention;

FIG. 3 is a flow chart illustrating one example of the aspect ratio changing process in the broadcasting reception device according to one embodiment of the present invention;

FIG. 4 is an explanatory diagram illustrating one example of a corresponding relationship between an input signal from a PC and an aspect ratio of a display section in the broadcasting reception device according to one embodiment of the present invention;

FIG. 5 is an explanatory diagram illustrating one example of screen display setting in the broadcasting reception device according to one embodiment of the present invention;

FIG. 6 is an explanatory diagram illustrating one example of a display of a video signal shown on the display section in the broadcasting reception device according to one embodiment of the present invention;

FIG. 7 is a flow chart illustrating one example of the aspect ratio changing process in the broadcasting reception device according to one embodiment of the present invention;

FIG. 8 is a flow chart illustrating one example of the aspect ratio changing process in a PC device which has received aspect ratio information from the broadcasting reception device according to one embodiment of the present invention;

FIG. 9 is an explanatory diagram illustrating one example of EDID before a change supplied from the broadcasting reception device to the PC device according to one embodiment of the present invention;

FIG. 10 is an explanatory diagram illustrating one example of EDID before the change supplied from the broadcasting reception device to the PC device according to one embodiment of the present invention;

FIG. 11 is an explanatory diagram illustrating one example of EDID before the change supplied from the broadcasting reception device to the PC device according to one embodiment of the present invention;

FIG. 12 is an explanatory diagram illustrating one example of EDID before the change supplied from the broadcasting reception device to the PC device according to one embodiment of the present invention;

FIG. 13 is an explanatory diagram illustrating one example of EDID before the change supplied from the broadcasting reception device to the device according to one embodiment of the present invention;

FIG. 14 is an explanatory diagram illustrating one example of EDID before the change supplied from the broadcasting reception device to the PC device according to one embodiment of the present invention;

FIG. 15 is an explanatory diagram illustrating one example of EDID showing an aspect ratio for PC video after the change supplied from the broadcasting reception device to the PC device according to one embodiment of the present invention;

FIG. 16 is an explanatory diagram illustrating one example of EDID showing an aspect ratio for PC video after the change supplied from the broadcasting reception device to the PC device according to one embodiment of the present invention;

FIG. 17 is an explanatory diagram illustrating one example of EDID showing an aspect ratio for PC video after the change supplied from the broadcasting reception device to the PC device according to one embodiment of the present invention;

FIG. 18 is an explanatory diagram illustrating one example of EDID showing an aspect ratio for PC video after the change supplied from the broadcasting reception device to the PC device according to one embodiment of the present invention;

FIG. 19 is an explanatory diagram illustrating one example of EDID showing an aspect ratio for PC video after the change supplied from the broadcasting reception device to the PC device according to one embodiment of the present invention;

FIG. 20 is an explanatory diagram illustrating one example of EDID showing an aspect ratio for PC video after the change supplied from the broadcasting reception device to the PC device according to one embodiment of the present invention;

FIG. 21 is an explanatory diagram illustrating one example of EDID showing an aspect ratio for a digital camera video after the change supplied from the broadcasting reception device to a digital camera according to one embodiment of the present invention;

FIG. 22 is an explanatory diagram illustrating one example of EDID showing aspect ratio information for a digital camera video after the change supplied from the broadcasting reception device to the digital camera according to one embodiment of the present invention;

FIG. 23 is an explanatory diagram illustrating one example of EDID showing aspect ratio information for a digital camera video after the change supplied from the broadcasting reception device to the digital camera according to one embodiment of the present invention;

FIG. 24 is an explanatory diagram illustrating one example of EDID showing aspect ratio information for a digital camera video after the change supplied from the broadcasting reception device to the digital camera according to one embodiment of the present invention;

FIG. 25 is an explanatory diagram illustrating one example of EDID showing aspect ratio information for a digital camera video after the change supplied from the broadcasting reception device to the digital camera according to one embodiment of the present invention; and

FIG. 26 is an explanatory diagram illustrating one example of EDID showing aspect ratio information for a digital camera video after the change supplied from the broadcasting reception device to the digital camera according to one embodiment of the present invention.

### DETAILED DESCRIPTION

Various embodiments according to the invention will be described hereinafter with reference to the accompanying drawings. In general, according to one embodiment of the invention, a broadcasting reception device comprising: a tuner section which selects and outputs a television broadcasting signal; a demodulating section which demodulates the broadcasting signal from the tuner section so as to output a video signal; a display section which displays a video according to the video signal from the demodulating section on a screen; and a signal processing section which, when a determination is made that a predetermined condition is satisfied, processes the video signal and supplies it to the display section so that the video signal is displayed on the display section by means of dot-by-dot.

One embodiment of the present invention provides a broadcasting reception device which can clearly display a PC image on a screen of a television device and a signal processing method for the broadcasting reception device.

One embodiment for achieving the object is a broadcasting reception device comprising:

a tuner section (11) which selects and outputs a television broadcasting signal;

a demodulating section (15) which demodulates the broadcasting signal from the tuner section so as to output a video signal;

a display section (24) which displays a video according to the video signal from the demodulating section on a screen; and

a signal processing section (20) which, when a determination is made that a predetermined condition is satisfied, processes the video signal and supplies it to the display section so that the video signal is displayed on the display section by means of dot-by-dot.

When a PC image signal including a still image and supplied from a D-Sub terminal or an HDMI terminal is recognized, this PC image signal is automatically set for dot-by-dot display in which format conversion and a scaling process are not performed, and the clear PC image is displayed on a screen of a television receiver without user's operation.

The embodiment of the present invention will be described in detail below with reference to the drawings.

<One Example of the Broadcasting Reception Device According to One Embodiment of the Present Invention>

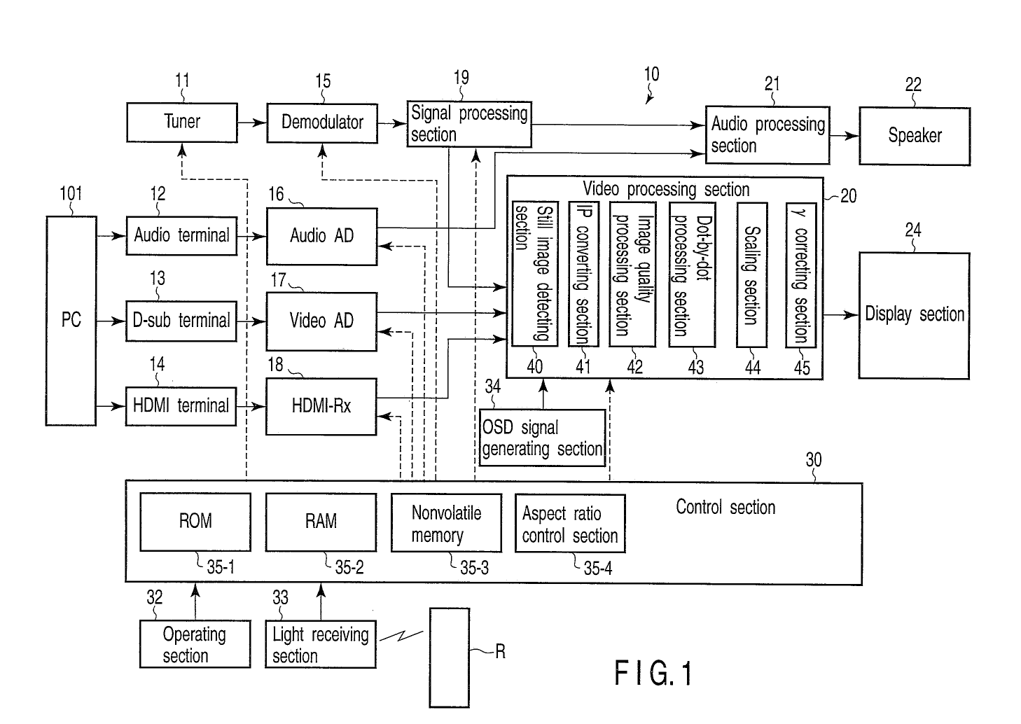

One example of the broadcasting reception device according to one embodiment of the present invention will be described in detail below with reference to the drawings. FIG. 1 is a block diagram illustrating one example of a constitution of the broadcasting reception device according to one embodiment of the present invention.

(Constitution of the Broadcasting Reception Device)

One example of the constitution of a broadcasting reception device 10 such as a digital television device according to one embodiment of the present invention will be described in detail below with reference to the drawings. FIG. 1 is a block diagram illustrating one example of the constitution of the broadcasting reception device according to one embodiment of the present invention.

As shown in FIG. 1, in the broadcasting reception device 10, a control section 30 is connected to respective sections via a data bus in order to control an entire operation. The control section 30 includes a ROM 35-1, a RAM 35-2, a nonvolatile memory 35-3 and an aspect ratio control section 35-4.

The broadcasting reception device 10 further has an audio terminal 12, a D-Sub terminal 13 and an HDMI (High-Definition Multimedia Interface) terminal 14 as examples of dedicated terminals to which a PC video signal is supplied from a PC device on an input side. They are connected to an audio AD converting section 16, a video AD converting section 17, and an HDMI receiving section 18, respectively. The D-sub terminal 13 and the HDMI terminal 14 are connected to a PC device 101, for example. The dedicated terminals to which a PC video signal is supplied from the PC device are not limited to the D-Sub terminal 13 and the HDMI terminal 14, and any terminals which can be used for supplying video signals from the PC device may be used.

As shown in FIG. 1, the broadcasting reception device 10 further has a tuner section 11 such as a digital TV tuner or an analogue TV tuner, a demodulator 15, a signal processing section 19, an audio processing section 21, and a speaker 22. The demodulator 15 demodulates a channel selecting signal from the tuner section 11. The signal processing section 19 processes a signal from the demodulator 15. The audio processing section 21 amplifies an audio signal from the signal processing section 19 or the audio AD converting section 16. The audio signal is supplied to the speaker 22.

As shown in FIG. 1, the broadcasting reception device 10 further has a video processing section 20, an OSD signal generating section 34, and a display section 24. Video signals from the video AD converting section 17 and the HDMI receiving section 18 and a video signal from the signal processing section 19 are supplied to the video processing section 20. The OSD signal generating section 34 generates operation information and program information to be superimposed on an original video signal. A video signal from the video processing section 20 is supplied to the display section 24.

As shown in FIG. 1, the broadcasting reception device 10 has an operating section 32 such as respective setting switches for channels and volumes, a remote controller R which performs an approximately equivalent operation to the operating section 32, and a light receiving section 33 for the remote controller R as an operating system.

The video processing section 20 has a still image detecting section 40 which determines whether a video signal is a still image or includes a lot of still images by comparing adjacent inter-frame images in the video signal. The video signal processing section 20 has an IP converting section 41, an image quality processing section 42, a dot-by-dot processing section 43, a scaling section 44 and a γ correcting section 45. The IP converting section 41 converts an interlace signal into a progressive signal. The image quality processing section 42 executes a coring process and an enhancing process. The dot-by-dot processing section 43 executes a dot-by-dot process. The scaling section 44 executes a scaling process. The γ correcting section 45 executes a γ correcting process on a video signal.

(Operation)

In the broadcasting reception device 10 having such a constitution, a broadcasting signal is input from a receiving antenna into the tuner section 11, and a channel is selected here. A packet-type demodulated signal which is selected and demodulated is demodulated by the demodulator 15, and is separated into packets according to types in the signal processing section 19. An audio-video packet is decoded by an MPEG decoder so as to become a video-audio signal, and then supplied to the audio processing section 21 and the video processing section 20. In the video processing section 20, the IP converting section 41 converts the given video signal as the interlace signal into a progressive signal, and the image quality processing section 42 executes the coring process and the enhancing process on the video signal. The scaling section 44 executes the scaling process on the video signal, and the γ correcting section 45 γ-corrects the video signal. Thereafter, a video of television broadcasting according to the processed video signal is displayed on the display section 24.

<One Example of Aspect Ratio Process in the Broadcasting Reception Device According to One Embodiment of the Present Invention>

One example of an aspect ratio process in the broadcasting reception device 10 according to one embodiment of the present invention will be described in detail below with reference to the drawings.

In the aspect ratio process, when a PC video signal is input into a television receiver having a display such as LCD driven per pixel, the broadcasting reception device 10 determines whether the video is a moving image or a still image, and when the video is a still image, automatically changes an aspect ratio so as to be suitable for the still image. As a result, a video optimum for a still image of a PC video can be provided without forcing a user to perform a complicated operation.

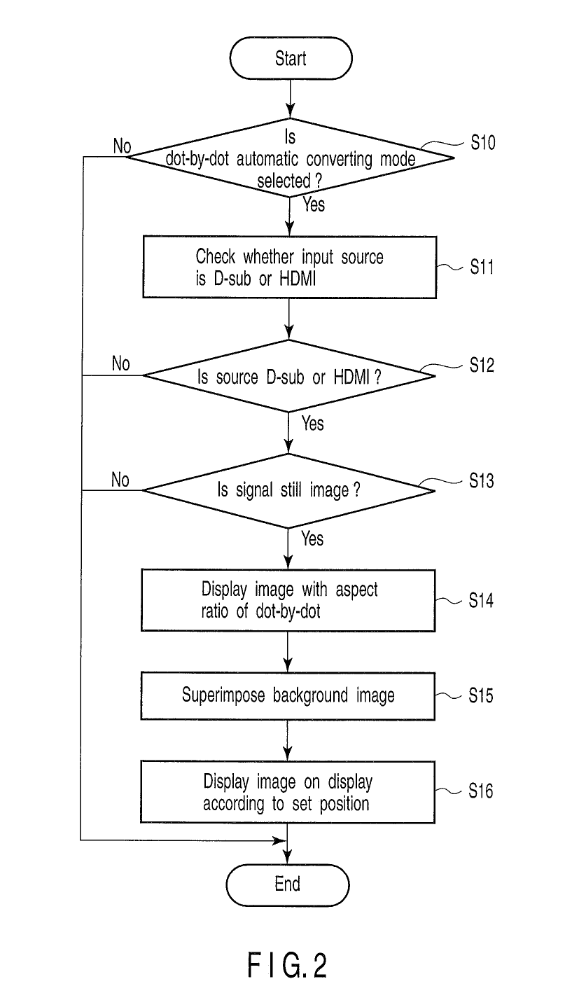

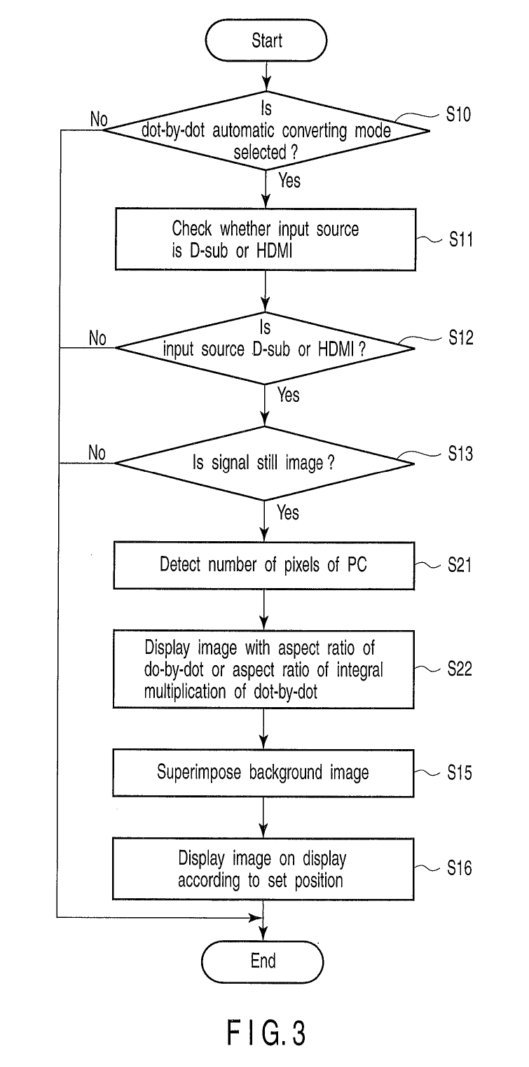

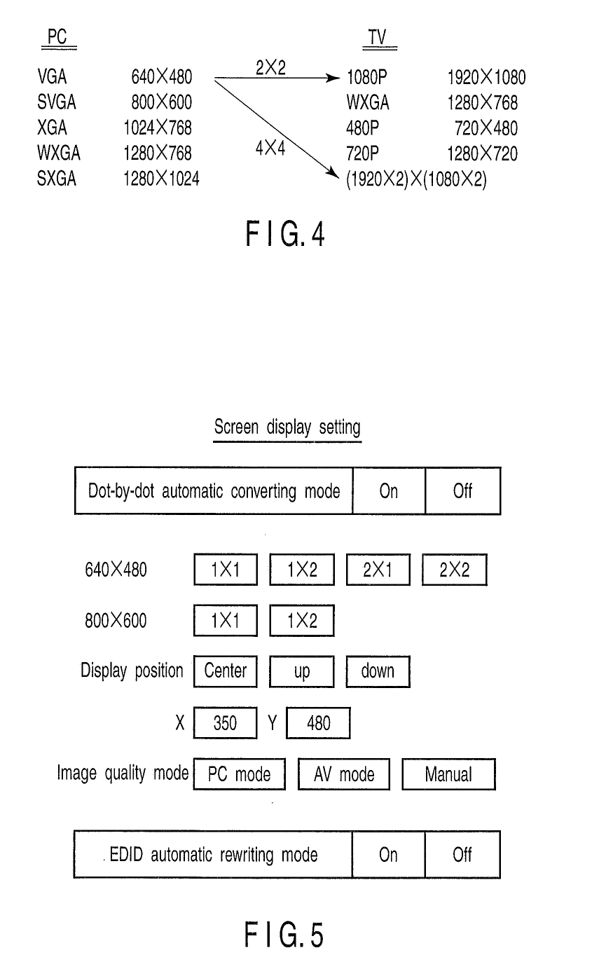

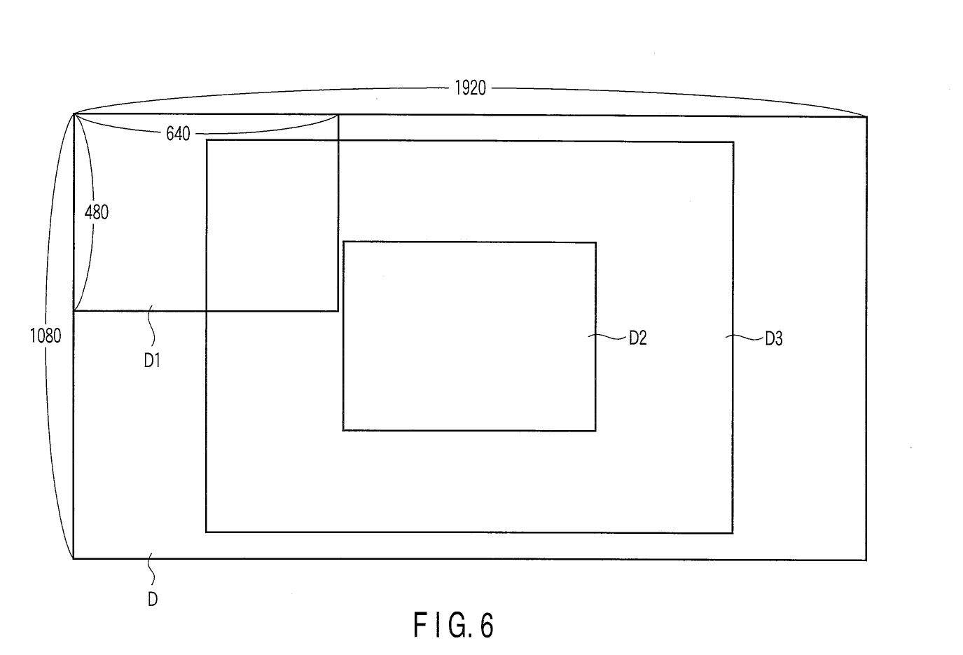

FIG. 2 is a flow chart illustrating one example of the aspect ratio changing process in the broadcasting reception device according to one embodiment of the present invention. FIG. 3 is a flow chart illustrating one example of the aspect ratio changing process in the broadcasting reception device. FIG. 4 is an explanatory diagram illustrating one example of a corresponding relationship between an input signal from a PC and an aspect ratio of the display section in the broadcasting reception device. FIG. 5 is an explanatory diagram illustrating one example of screen display setting in the broadcasting reception device. FIG. 6 is an explanatory diagram illustrating one example of display of a video signal shown on the display section in the broadcasting reception device.

Respective steps in the flow charts in FIGS. 2, 3, 7 and 8 are realized by computer programs and a computer which executes the programs. The steps in the flow charts of FIGS. 2, 3, 7 and 8 can be replaced by circuit blocks, and thus all the steps in the flow charts can be redefined as blocks.

In the broadcasting reception device 10 according to one embodiment of the present invention, as shown in the flow chart of FIG. 2, the control section 30 and the aspect ratio control section 35-4 determine whether “a dot-by-dot automatic changing mode” is already turned on by the screen display setting shown in FIG. 5 by referring to the RAM-2. When the control section 30 and the aspect ratio control section 35-4 determine that the “dot-by-dot automatic changing mode” is already turned on and any video signal is supplied from a terminal (step S11), they check whether the video signal is supplied from the D-Sub terminal or the HDMI terminal (step S12).

When the video signal is not supplied from the D-Sub terminal or the HDMI terminal, the control section 30 and the aspect ratio control section 35-4 do not execute the dot-by-dot process. The scaling section 44 executes the normal scaling process so that an image according to the video signal is displayed on the display section 24 with its size conforming to its screen.

When the control section 30 and the aspect ratio control section 35-4 determine that the video signal is supplied from the D-Sub terminal or the HDMI terminal, they determine whether the video signal is a still image (step S13). When the control section 30 and the aspect ratio control section 35-4 do not determine that the video signal is a still image, they do not process the dot-by-dot process as usual. The scaling section 44 executes the normal scaling process so that an image according to the video signal is displayed on the display section 24 with its size conforming to its screen.

When the control section 30 and the aspect ratio control section 35-4 determine that the video signal is a still image based on a detected result of the still image detecting section 40, the dot-by-dot processing section 43 of the video processing section 20 processes the video signal so that the image according to the video signal is displayed at an aspect ratio of dot-by-dot. That the video signal is a still image may include a case where the entire video signal is a still image or a case where a constant amount of the video signal is a still image according to users' demands.

The dot-by-dot means that the scaling process is not executed on a video signal and an image is displayed directly according to the number of pixels of the display. As a result, the number of ruled lines of the spreadsheet application is prevented from becoming two and one, so that an entire image does not become clear.

A relationship between a standard of the display section 24 and a standard of the PC video signal is considered with reference to FIG. 4. The standard of a PC video signal includes the following:

“VGA: 640×480”

“SVGA: 800×600”

“XGA: 1024×768”

“WXGA: 1280×768”

“SXGA: 1280×1024”.

The size of the display section 24 of TV includes the following:

“1080P: 1920×1080”

“WXGA: 1280×768”

(in the case of 1366×768, some are called as WXGA panel”

“480P: 720×480”

“720P: 1280×720”

“(1920×2)×(1080×2)”.

At this time, the dot-by-dot display is enabled in the case where:

(number of pixels of PC video signal)<(number of pixels of display section).

With “VGA: 640×480”, a signal is doubled in horizontal and vertical directions so as to be displayed with “1080P: 1920×1080”.

Thereafter, since a background goes blank in the case of the dot-by-dot display, the control section 30 and the aspect ratio control section 35-4 generate a background image so as to superimpose it on an image signal (step S15). In such a manner, when a PC video signal “VGA: 640×480” is displayed on the display section “1080P: 1920×1080”, the PC video signal is displayed like a display region D1 or a display region D2 of FIG. 6.

As a result, a video of the PC video signal can be displayed by the dot-by-dot display without user's special operation. In this display method, a video signal is prevented from being scaled with an odd numerical value such as “1.7258 times”, and thus an unclear image in which ruled lines of the spreadsheet application becomes thick or thin is not generated.

In the flow chart of FIG. 2, when “an input source is supplied from the D-Sub terminal or the HDMI terminal” and “the PC video signal is a still image”, the dot-by-dot process is executed for the first time. However, the present invention is not limited to these description.

That is to say, as to the condition of the dot-by-dot process, only one of the above conditions may be satisfied, or some of many conditions can be essential. Therefore, the condition may be “a determination is made that a video signal is supplied to the broadcasting reception device 10 via a terminal dedicated for a PC video signal”, or a concrete terminal dedicated for a PC video signal may be specified. The condition may include only a condition that “a PC video signal is a still image”, or they may be combined.

The condition that “a PC video image is a still image” may not be essential, and it is preferable that the dot-by-dot process is executed when a video signal is a moving image. That is to say, the dot-by-dot process may or may not be executed, and when the condition meets a user's desirable condition, the dot-by-dot process is preferably executed.

When the dot-by-dot process is executed on a PC video signal and a treated signal is not an AV video signal but a PC video signal, sharpness and contrast of the video signal are enhanced, so that a clearer PC video is displayed.

The screen display setting in FIG. 5 is an item which can be set as an initial setting item by a user's operation using the remote controller R. A determination is made whether “the dot-by-dot automatic changing mode” is turned on/off and whether dot-by-dot is integrally multiplied at the time of “PC video signal: 640×480” or “PC video signal: 800×600”. Positions of the display regions of the dot-by-dot on the display screen of the display section 24 are set as “center” and “up”, so that the display coordinates can be determined.

On an image quality mode, various settings are enabled in such a manner that the sharpness and contrast are enhanced in the case of the PC video signal, and illuminance is increased in the case of the AV video signal.

In the flow chart of FIG. 3, since steps S10 to S13 and steps S15 to S16 are common to the flow chart in FIG. 2, the description thereof is omitted. At step S21 in the flow chart of FIG. 3, the control section 30 and the aspect ratio control section 35-4 detect the number of pixels of a PC video signal, and compare the detected number of pixels with the current number of pixels of the display section 24 (step S21). When the display process of integral multiple (2×2) is set on the initial setting, like the display region D3 in FIG. 6, the PC video signal “VGA: 640×480” is enlarged with the integral multiple (2×2) so as to be displayed.

When the PC video signal is enlarged with integral multiple, a distortion of the calculation does not occur. For this reason, a clear video can be displayed similarly to the dot-by-dot without causing a distortion on the PC video screen unlike the conventional techniques.

<One Example of the Aspect Ratio Process According to One Embodiment of the Present Invention>

One example of the aspect ratio process according to one embodiment of the present invention will be described in detail below with reference to the drawings.

In the HDMI standard, recommended aspect ratio information is provided by supplying EDID (Extended Display Identification Data) from the broadcasting reception device 10 to the PC device 101. In this embodiment, when a PC video signal comes from the PC device 101, the recommended aspect ratio information is automatically rewritten from information for AV video signal into information for PC video signal. As a result, the PC device 101 on an opponent side can acquire the aspect ratio information for PC video signal which is efficiently treated by the broadcasting reception device 10, and converts and supplies the video signal according to the recommended aspect ratio information. As a result, a clearer image of the video signal from the PC device 101 can be displayed without a user's special operation.

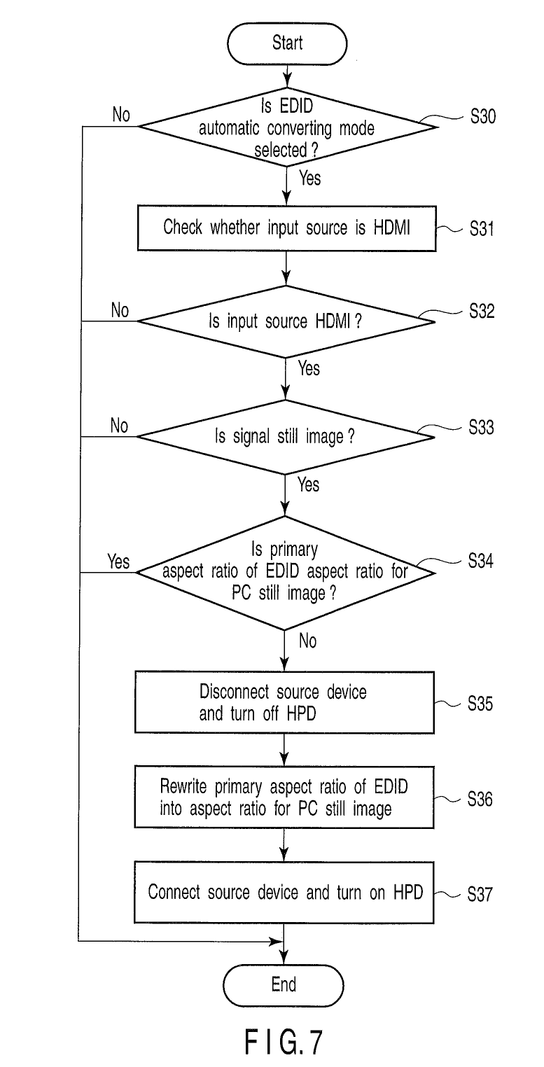

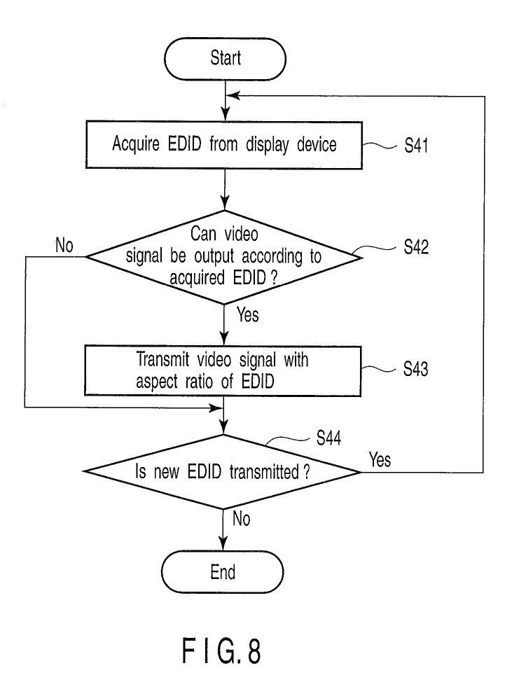

FIG. 7 is a flow chart illustrating one example of the aspect ratio changing process in the broadcasting reception device 10 according to one embodiment of the present invention. FIG. 8 is a flow chart illustrating one example of the aspect ratio changing process in the PC device which has received the aspect ratio information from the broadcasting reception device 10.

That is to say, in the flow chart shown in FIG. 7, the control section 30 and the aspect ratio control section 35-4 determine whether an EDID automatic switching mode is selected at initial setting (step S30). When this mode is selected, the control section 30 and the aspect ratio control section 35-4 determine whether an input source is supplied from the HDMI terminal (step S31). When the input source is supplied from the HDMI terminal (step S32), the control section 30 and the aspect ratio control section 35-4 determine whether this video signal is a still image (step S33).

When the video signal is a still image (step S33), the control section 30 and the aspect ratio control section 35-4 determine whether a primary aspect ratio of EDID supplied from the HDMI terminal to the opponent PC device 101 is aspect ratio information for PC video signal (step S34). When the determination is made that the primary aspect ratio is not the aspect ratio information for PC video signal, the control section 30 and the aspect ratio control section 35-4 disconnect the source device (PC device 101), and turn off HPD (Hot Plug Detect) (step S35). The control section 30 and the aspect ratio control section 35-4 then rewrite the primary aspect ratio of EDID into the aspect ratio information for PC video signal (step S36). The control section 30 and the aspect ratio control section 35-4 then again connect the source device and turn on the HPD (step S37).

As a result, the PC device 101 converts the video signal into the aspect ratio information for PC video signal recommended by the broadcasting reception device 10, and can display a clear image on the display section 24 of the broadcasting reception device 10.

(Modified Example of EDID)

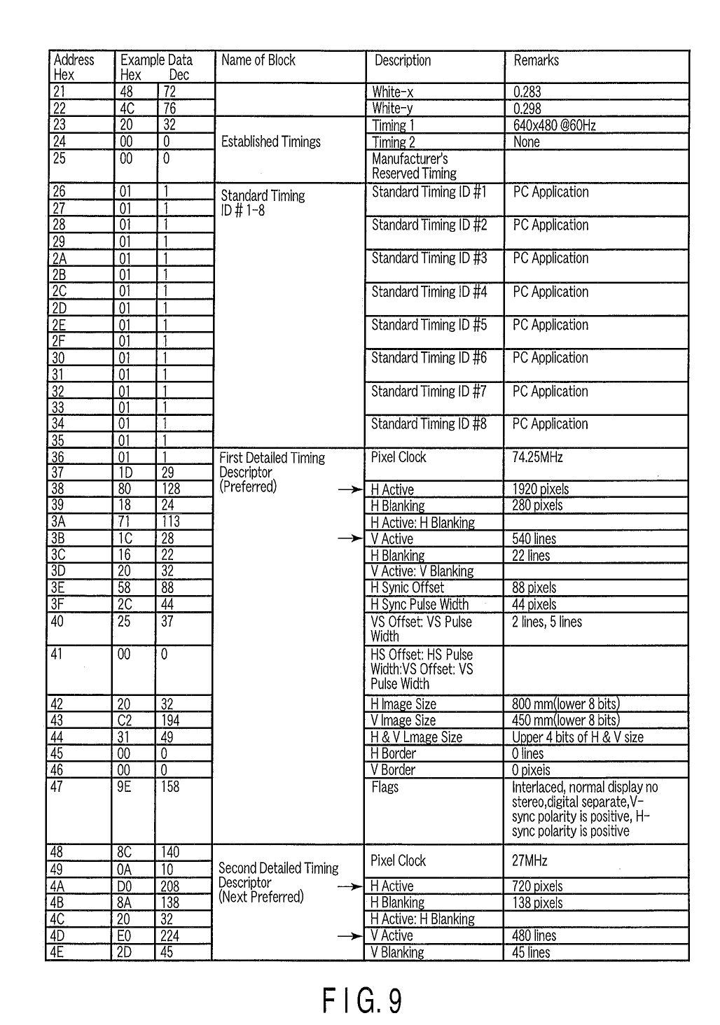

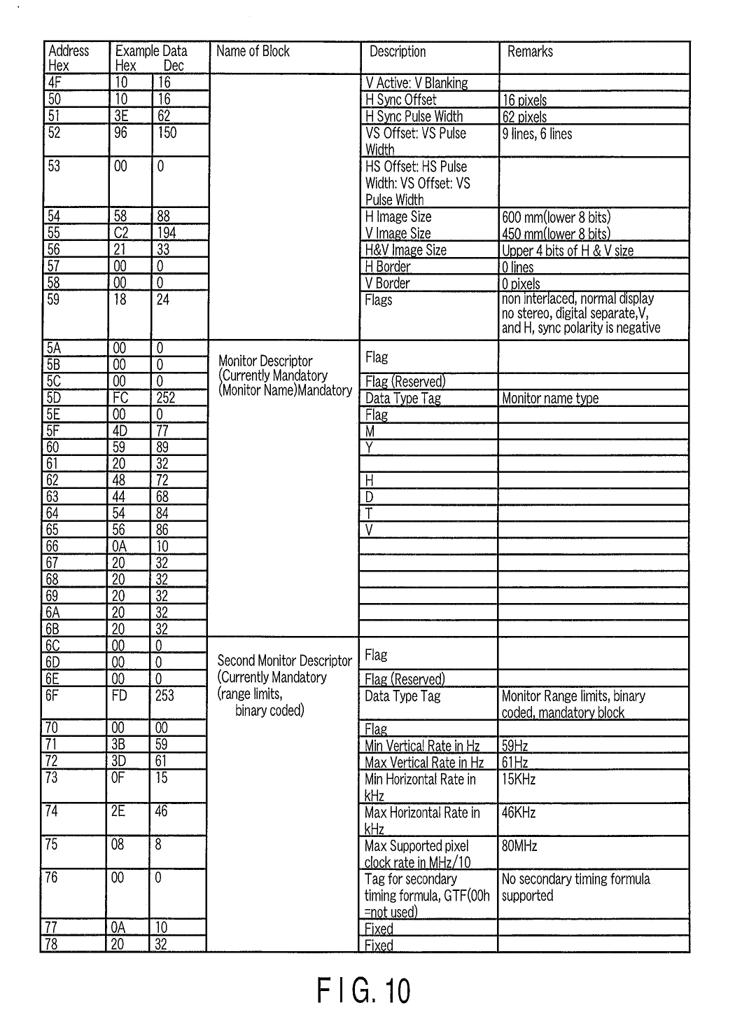

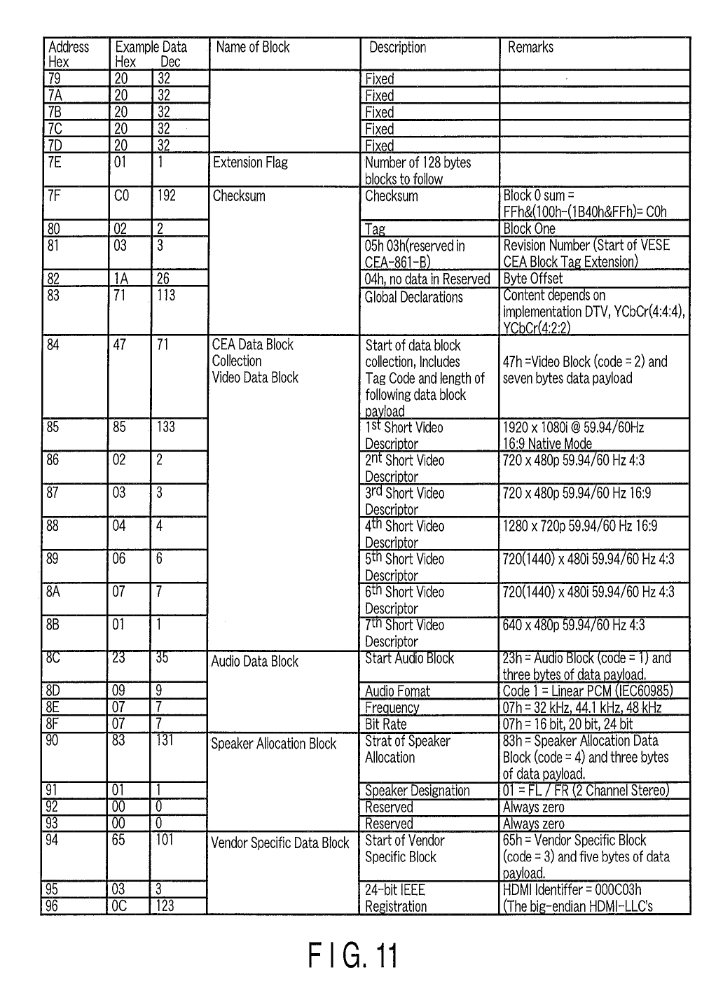

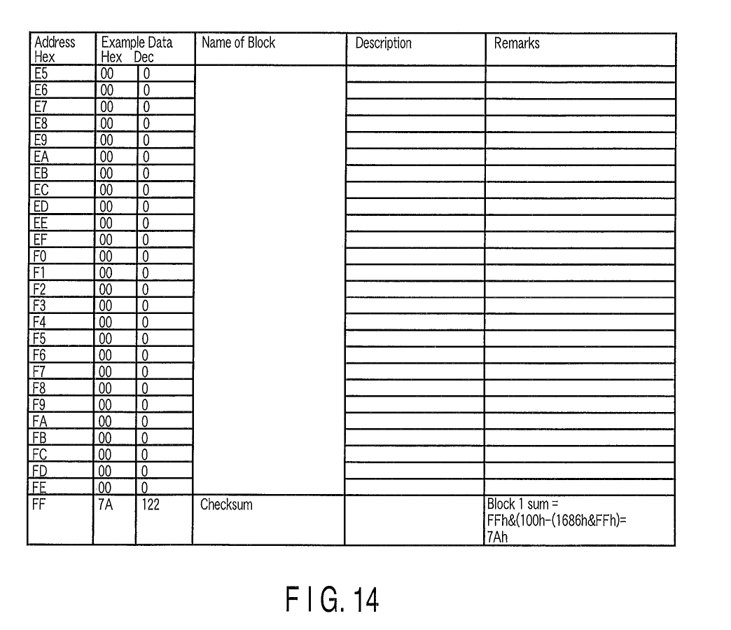

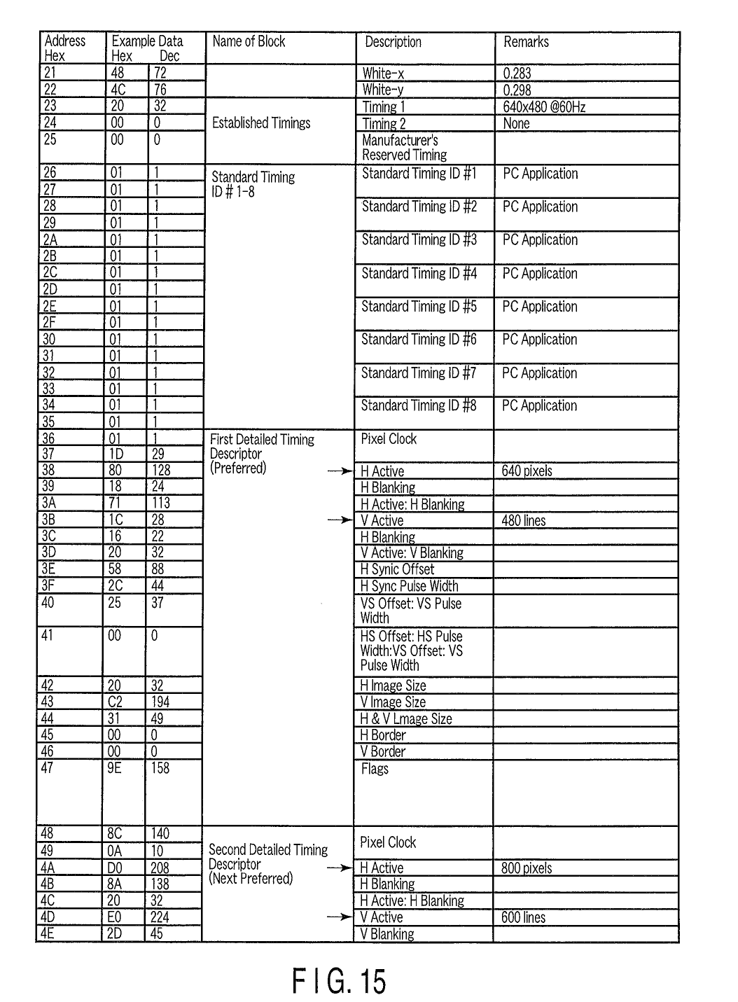

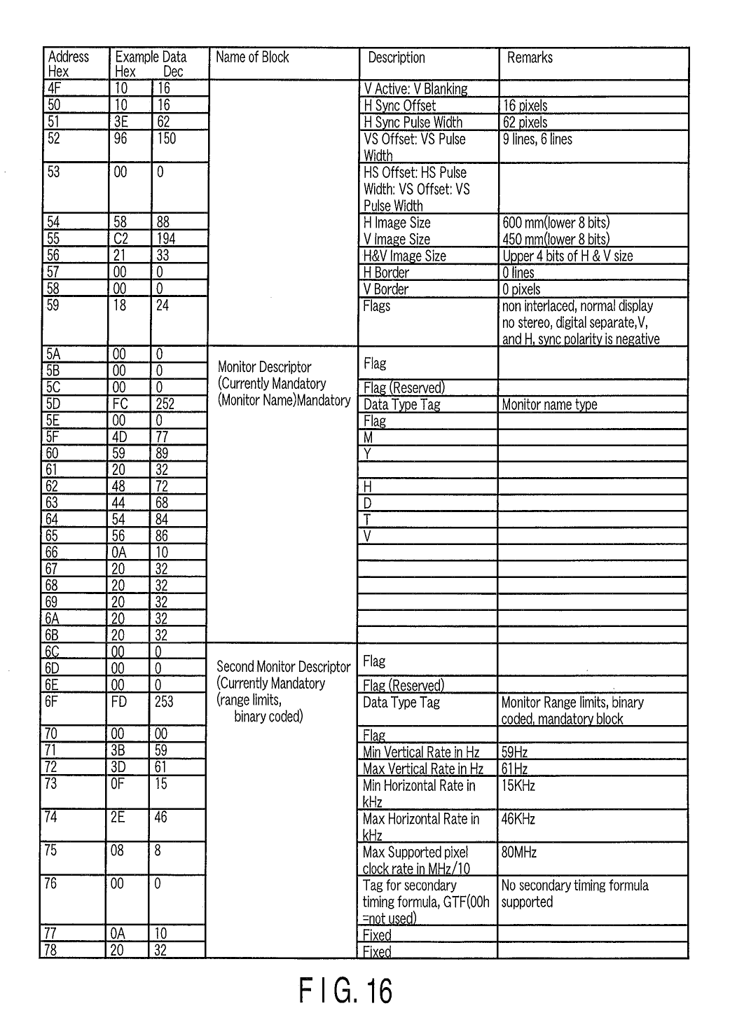

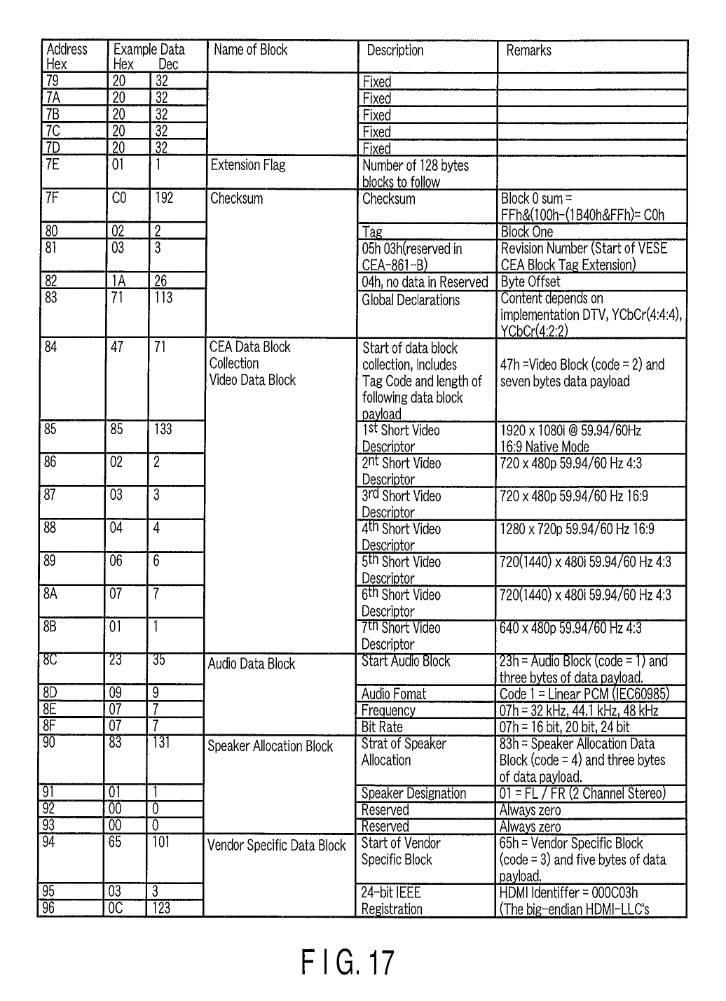

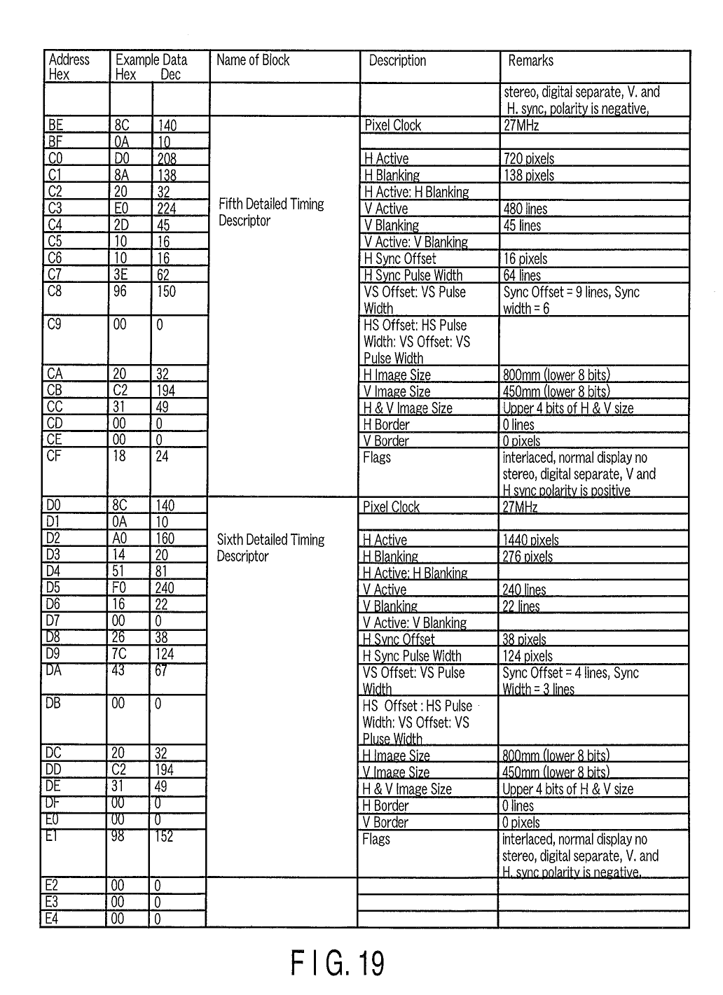

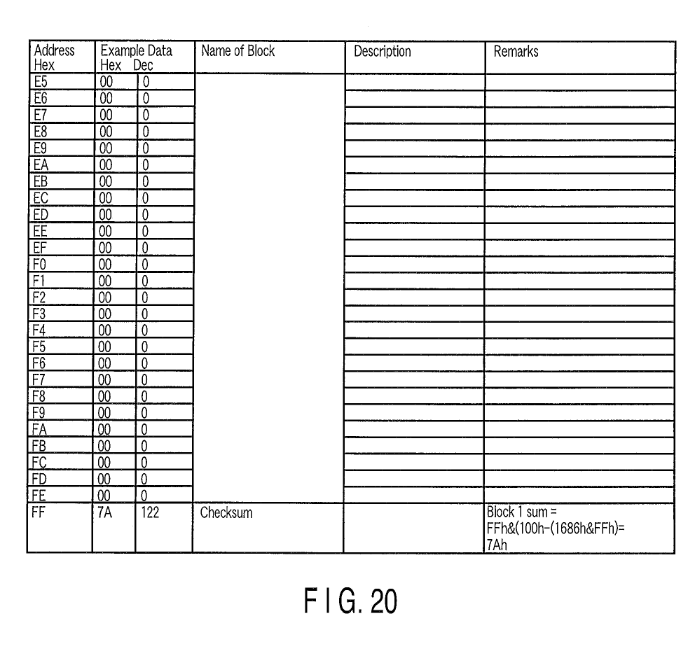

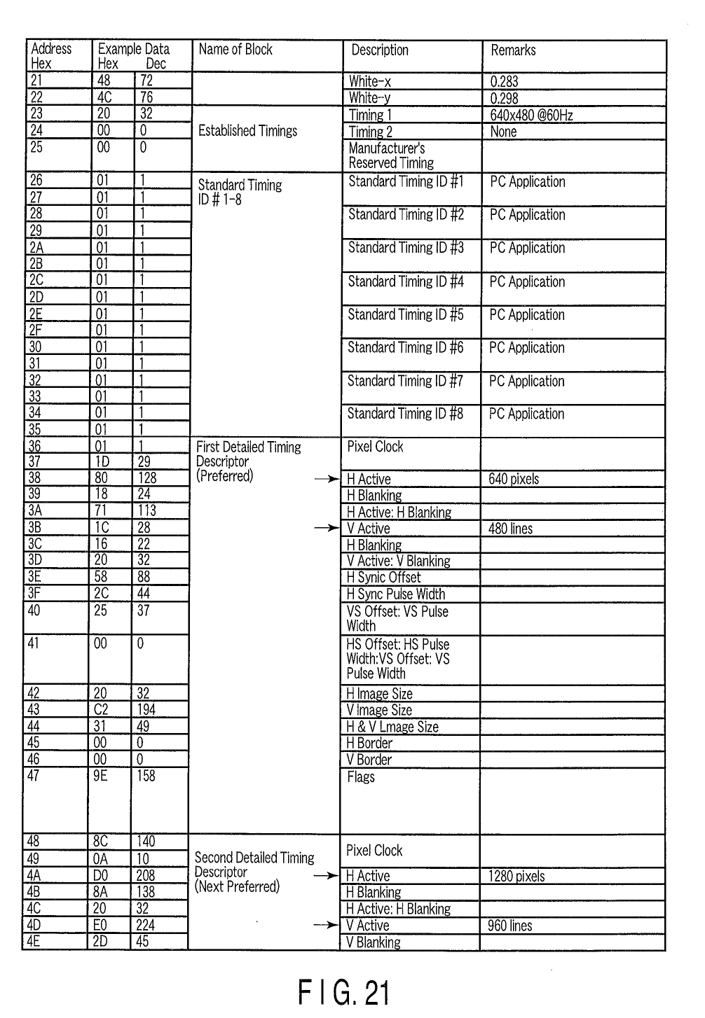

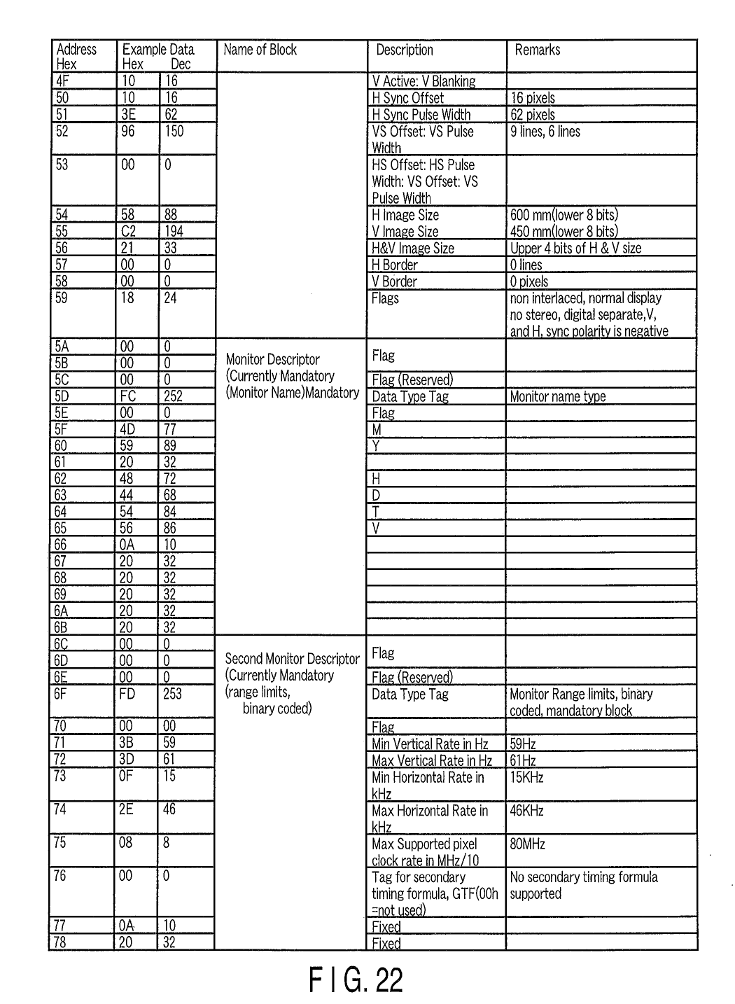

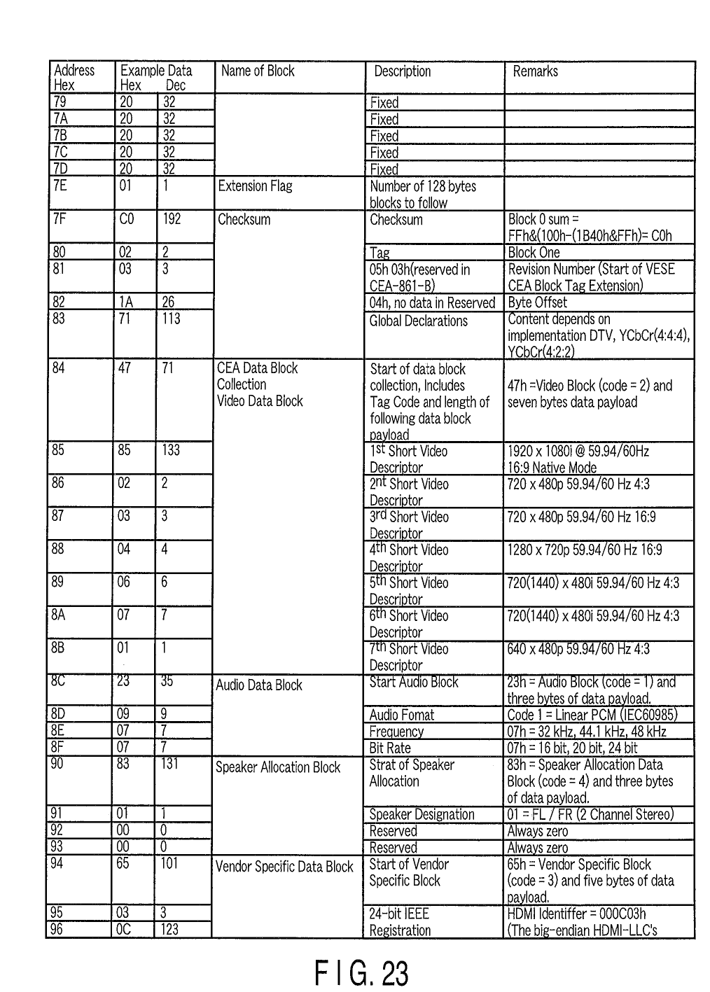

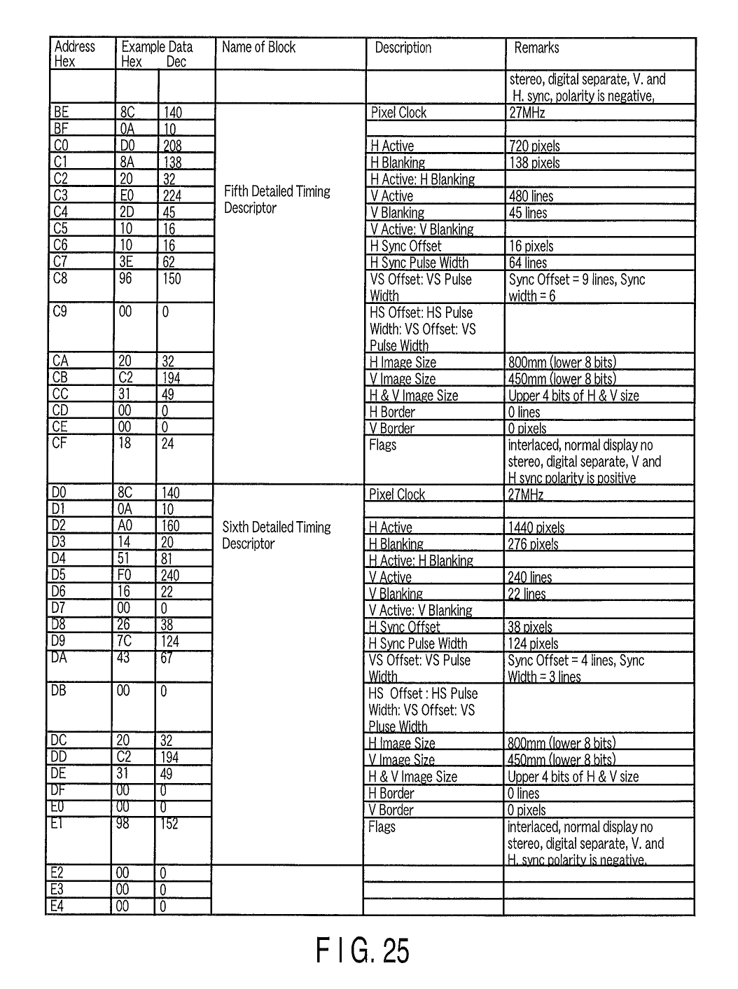

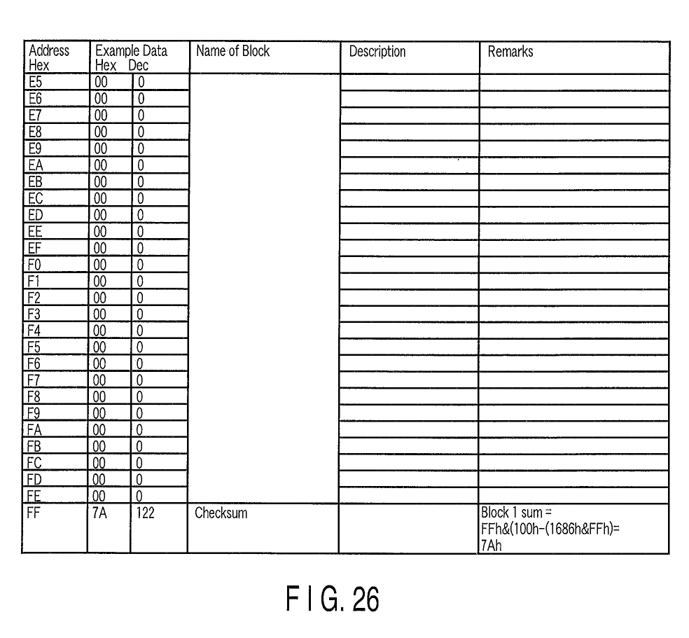

A concrete modified example of EDID will be described below. FIGS. 9 to 14 are explanatory diagrams illustrating examples of EDID before the change supplied from the broadcasting reception device 10 to the PC device according to one embodiment of the present invention. FIGS. 15 to 20 illustrate EDID showing the aspect ratio information for PC video signal after the change. FIGS. 21 to 26 illustrate EDID showing the aspect ratio information for digital camera video after the change supplied to a digital camera.

Aspect Ratio Information for AV Video Signal Before Change

FIGS. 9 to 14 illustrate examples of EDID showing the aspect ratio information for AV video signal before the change.

That is to say, in FIG. 9, in First Detailed Timing Descriptor (Preferred), the video standard “1920×1080” (1080i) is recommended as the aspect ratio information for AV video signal.

Similarly in FIG. 9, in Second Detailed Timing Descriptor (Next Preferred), the video standard “720×480” (480p_H720) is recommended as the aspect ratio information for AV video signal.

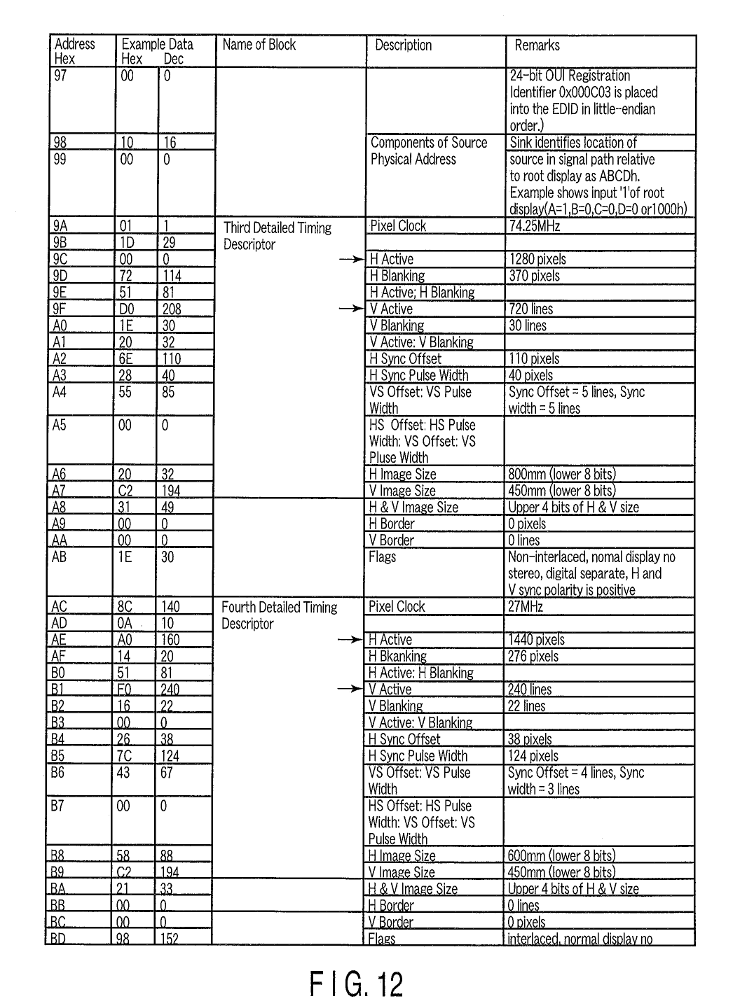

In FIG. 12, in Third Detailed Timing Descriptor, the video standard “1280×720” (720p) is recommended as the aspect ratio information for AV video signal.

In FIG. 12, in Fourth Detailed Timing Descriptor, the video standard “1440×480” (480i_H1440) is recommended as the aspect ratio information for AV video signal.

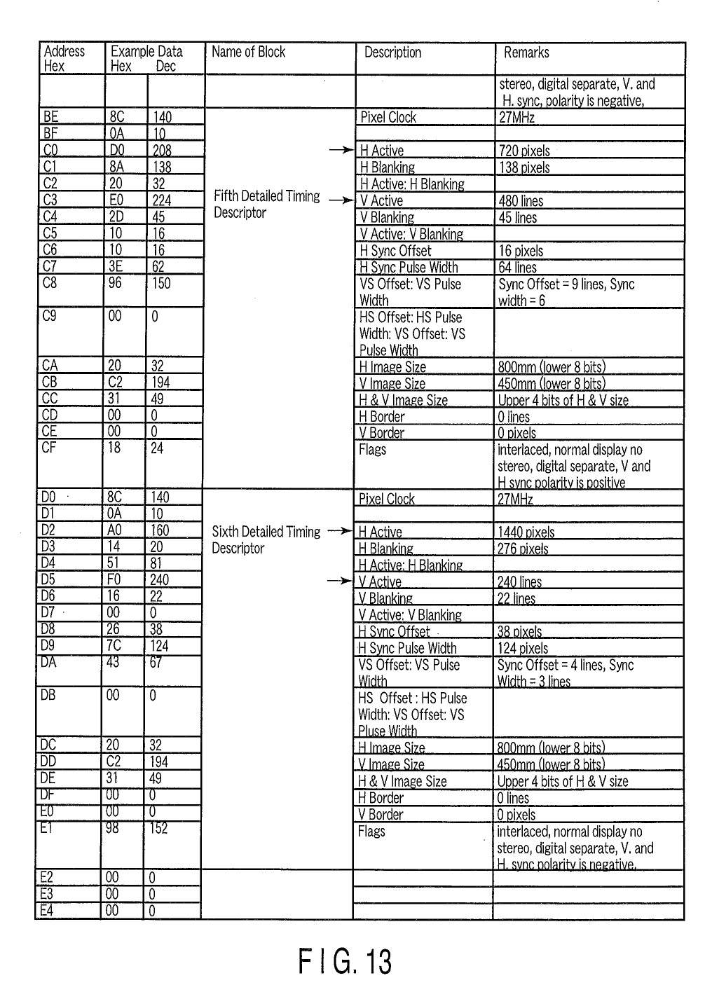

In FIG. 13, in Fifth Detailed Timing Descriptor, the video standard “720×960” (960i) is recommended as the aspect ratio information for AV video signal.

In FIG. 13, in Sixth Detailed Timing Descriptor, the video standard “1440×480” (480i_H1440) is recommended as the aspect ratio information for AV video signal.

Aspect Ratio Information for PC Video Signal

FIGS. 15 to 20 illustrate examples of EDID showing the aspect ratio information for PC video signal after the change.

That is to say, in FIG. 15, in First Detailed Timing Descriptor (Preferred), the video standard “VGA: 640×480” is recommended as the aspect ratio information for PC video signal.

In FIG. 15, in Second Detailed Timing Descriptor (Next Preferred), the video standard “SVGA: 800×600” is recommended as the aspect ratio information for PC video signal.

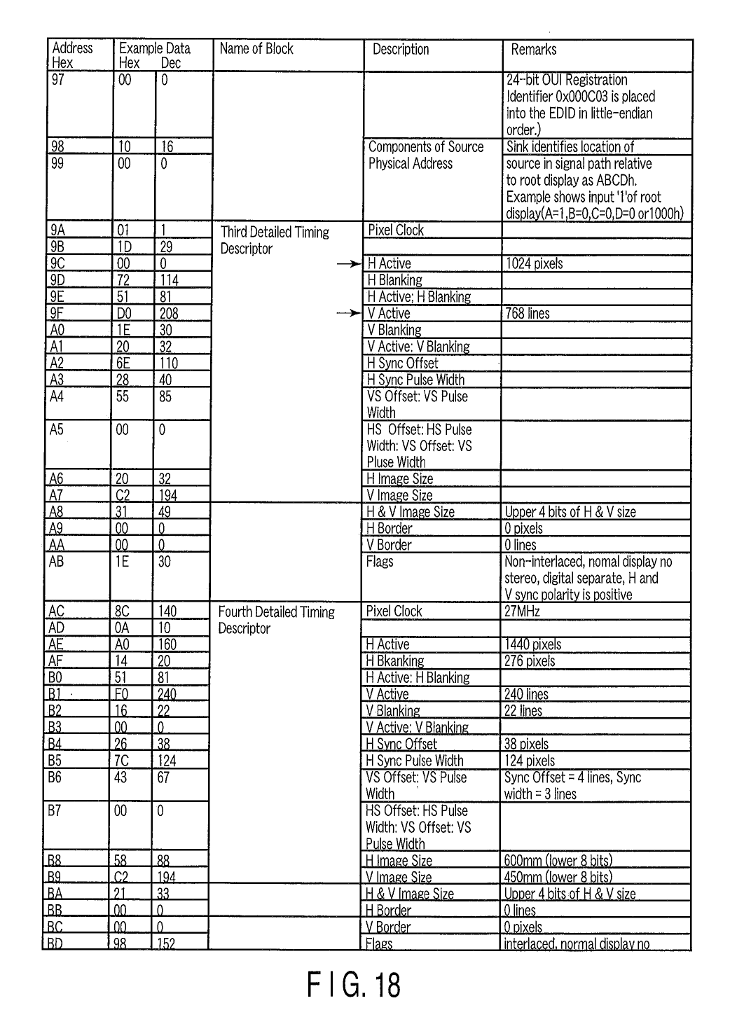

In FIG. 18, in Third Detailed Timing Descriptor, the video standard “XGA: 1024×768” is recommended as the aspect ratio information for PC video signal.

Aspect Ratio Information for Digital Camera Video

FIGS. 21 to 26 illustrate EDID showing the aspect ratio information for digital camera video after the change.

That is to say, in FIG. 21, in First Detailed Timing Descriptor (Preferred), the video standard “640×480” is recommended as the aspect ratio information for digital camera video.

In FIG. 21, in Second Detailed Timing Descriptor (Next Preferred), the video standard “1280×960” is recommended as the aspect ratio information for digital camera video.

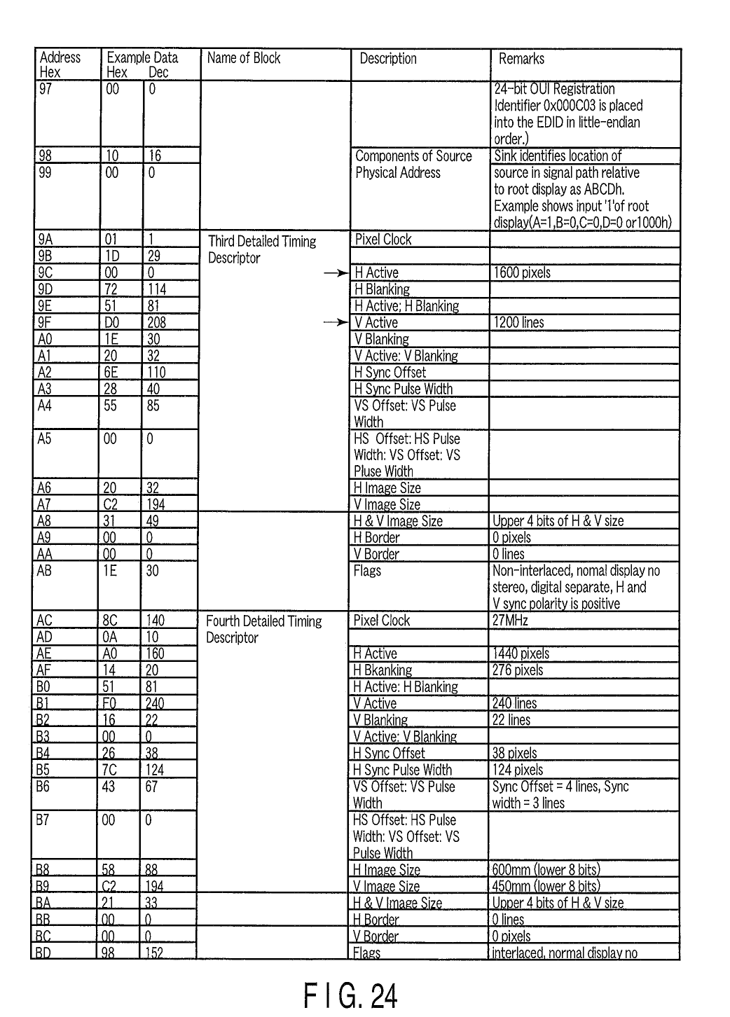

In FIG. 24, in Third Detailed Timing Descriptor, the video standard “1600×1200” is recommended as the aspect ratio information for digital camera video.

That is to say, when the aspect ratio information for digital camera video is supplied from the broadcasting reception device 10 to the external device (digital camera), a digital camera video signal can be supplied to the broadcasting reception device 10 and is displayed with an aspect ratio which conforms to the digital camera video.

(Aspect Ratio Changing Process in the PC Device 101)

That is to say, in the flow chart of FIG. 8, the PC device 101 acquires EDID from the broadcasting reception device 10 (step S41). The PC device 101 determines whether the video signal can be output according to the acquired EDID (step S42), and when possible, it transmits the video signal in a format of the aspect ratio for AV video signal shown by EDID (step S43).

As shown at step S36 in the flow chart of FIG. 7, the aspect ratio information for AV video signal is rewritten into the aspect ratio information for PC video signal, and is again sent to the PC device 101. When the PC device 101 detects that the new EDID is transmitted (step S44), the process returns to step S41, and the PC device 101 converts the video signal according to the aspect ratio information for PC video signal shown by the new EDID so as to transmit the converted signal to the broadcasting reception device (step S43).

As a result, the video signal according to the aspect ratio information for PC video signal recommended by the broadcasting reception device 10 is supplied from the PC device 101 to the broadcasting reception device 10 without a user's special operation. As a result, the clear PC image can be displayed on the display section 24 of the broadcasting reception device 10.

In the flow chart of FIG. 7, the EDID rewriting process is executed under the condition that the PC video signal is a still image, but this process is preferably executed even in the case where the video signal is a moving image. That is to say, the EDID rewriting process may or may not be executed, and thus the EDID rewriting process is preferably executed when the condition conforms to a user's desired condition.

When the EDID rewriting process is executed on a PC video signal and a signal to be treated is recognized not as an AV video signal but as a PC video signal, the sharpness and the contrast are enhanced for the video signal, and a more viewable PC video is provided.

On the screen display setting of FIG. 5, the user operates the remote controller R so that “EDID automatic rewriting mode” can be set as an initial setting item so as to be turned on/off.

According to the above embodiment, a person skilled in the art can realize the present invention, and further easily comes up with various modified examples of the embodiment. The present invention can be applied to various embodiments even without inventive ability. Therefore, the present invention covers a wide scope which is not inconsistent with the disclosed principle and new features, and thus the above embodiment is not restrictive.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcasting reception device comprising:
a tuner section which selects and outputs a television broadcasting signal;
a demodulating section which demodulates the broadcasting signal from the tuner section so as to output a video signal;
a display section which displays a video according to the video signal from the demodulating section on a screen; and
a signal processing section which, when a determination is made that a predetermined condition is satisfied, processes the video signal and supplies it to the display section so that the video signal is displayed on the display section by means of dot-by-dot.

2. The broadcasting reception device according to claim 1, wherein the signal processing section uses the predetermined condition such that the video signal is supplied via a terminal dedicated for a PC video signal.

3. The broadcasting reception device according to claim 1, wherein the signal processing section uses the predetermined condition such that the video signal is a still image.

4. The broadcasting reception device according to claim 1, wherein the signal processing section detects that a mode for displaying the video signal by means of dot-by-dot is selected, and processes the video signal to supply the signal to the display section in order to display the video signal on the display section by means of dot-by-dot.

5. The broadcasting reception device according to claim 1, wherein the signal processing section processes the video signal and supplies the signal to the display section in order to integrally multiply the video signal in one of horizontal and vertical directions and display the video signal on the display section.

6. The broadcasting reception device according to claim 1, wherein the signal processing section arranges a display region of dot-by-dot which conforms to the video signal on the display section according to input position information.

7. The broadcasting reception device according to claim 1, wherein when the display section conforms to a 1080P standard (1920×1080) and a video signal showing a still image conforms to a VGA standard (640×480), the signal processing section processes the video signal and supplies the signal to the display section in order to display an image according to the video signal with doubled pixels in a horizontal direction and doubled pixels in a vertical direction.

8. A signal processing method for a broadcasting reception device, comprising:
when detecting that a video signal showing a still image is supplied to the broadcasting reception device, processing the video signal and supplying the signal to a display section provided in the broadcasting reception device in order to display an image according to the video signal on the display section by means of dot-by-dot.

9. A broadcasting reception device comprising:
a tuner section which selects and outputs a television broadcasting signal;
a demodulating section which demodulates the broadcasting signal from the tuner section and outputs a video signal;
a display section which displays a video according to the video signal from the demodulating section on a screen; and
a signal processing section which, when a video signal showing a still image is supplied from an HDMI terminal and a primary aspect ratio of EDID is not an aspect ratio for PC video signal, disconnects an external device to which the video signal is supplied, rewrites the primary aspect ratio of EDID into an aspect ratio for PC video signal, and connects the external device.

10. The broadcasting reception device according to claim 9, wherein when the display section conforms to a 1080P standard (1920×1080), the aspect ratio for PC video signal written by the signal processing section includes at least one of a VGA standard (640×480), an SVGA standard (800×600) and an XGA standard (1024×768).
